(19) United States
(12) Patent Application Publication
(10) Pub. No.: US 2002/0138343 A1
(43) Pub. Date: Sep. 26, 2002

(54) Method of providing merchant rebates to purchasers

(76) Inventors: Harry Weatherford, Lenexa, KS (US); Curtis Driver, Mission, KS (US); Barbara Klinghoffer, Shawnee, KS (US); Marv Blevins, Lenexa, KS (US)

Correspondence Address: SPENCER, FANE, BRITT & BROWNE, 1000 WALNUT STREET, SUITE 1400, KANSAS CITY, MO, 64106-2140, US

(21) Appl. No.: 09/813,574

(22) Filed: Mar. 21, 2001

(51) Int. Cl. G06F 17/60

(52) U.S. Cl. 705/14; 705/39

(57) ABSTRACT

A method for awarding cash rebates from participating merchants to purchasers is provided in which the purchaser's use of a credit/debit card of a particular issuer to effect transactions at participating merchants will qualify the purchaser for the particular cash rebate percentage offered by the participating merchant.

### FIELD OF THE INVENTION

The present invention relates to the field of rebates or cash refunds to consumers based upon purchases transacted at participating stores. Specifically, a method is provided of identifying credit/debit transactions at a particular merchant using a particular credit/debit card to allow determination of a cash rebate to the consumer based upon the amount of a customer's transactions.

### BACKGROUND OF THE INVENTION

The concept of providing a rebate or a gift to consumers for directing their purchases to a particular store or product has long existed. In the past such rebate schemes have included the offering of a gift or premium for purchases of a particular product. An example of this type of consumer rebate is the laundry detergent which offered a piece of dinnerware or toweling within the product box. Another example of consumer rebates are the cents-off coupon which is redeemable at any store offering the product for sale. Yet another type of consumer rebate is the savings stamp in which a participating store provides the consumer with a stamp or a coupon based on a percentage of the total amount of purchases made by a consumer during a visit to a store. The stamps or coupons are then saved and redeemed for a variety of goods or prizes made available by the entity sponsoring the stamp or coupon redemption system.

As the sophistication of the consuming public has increased, the consumer has become less interested in receiving an additional product, prize or award for purchasing loyalty and more interested in receiving a true economic benefit. In general, the economic benefit of greatest interest to consumers is a reduction in the cost of the goods. One means of accomplishing a cost reduction of goods is through use of a manufacturer's cents-off coupon. However, the cents-off coupon represents an inconsistent method for the average consumer to obtain true cost savings. The coupons are not always available, nor are they always available for the products of interest to the consumer. Use of coupons necessitates a certain amount of memory and organizational skills which many consumers simply do not wish to expend on the act of purchasing. Cents-off coupons cannot be applied to all purchases made by the consumer, nor do cents-off coupons initiate any loyalty to any particular merchant. The cents-off coupon is redeemable at any store offering the particular goods for sale for which the coupon is issued. Therefore, a consumer has no impetus to trade at one store versus another on the basis of a cents-off coupon. From the consumer's point of view, the cents-off coupon is a cumbersome method of achieving savings and provides the consumer with only minor and sporadic actual savings.

A better method of providing the consumer with a real reduction cost in purchases is by means of the cash rebate method. While cash rebates have existed for particular products and provide a greater return to the consumer than the cents-off coupon, cash rebate offers generally are limited to a specific product and are sporadic in terms of their duration and do nothing to attract a particular consumer to a particular merchant. Rather, the manufacturer's merchandise rebate method is offered by a manufacturer to direct the consumer from one product to another product without regard to which merchant may be offering the goods for sale.

Another form of cash rebate is the credit card issuer rebate method. Under the credit card issuer rebate method, a consumer is provided with a percentage rebate of the total amount purchased using the credit card. The rebate is then paid by the issuer of the credit card to the card holder, typically, at an interval of once a year. While the credit card issuer cash rebate system may provide some degree of consumer loyalty to the particular credit card, it does nothing to provide a particular merchant with consumer loyalty as the loyalty achieved by the rebate is associated with the credit card company and not any particular merchant honoring the credit card. A limitation of the credit card issuer cash rebate system is that it does not include debit card transactions. Since debit card transactions are a direct deduction of money from the consumer's current account at a bank or savings and loan, the credit provider is not involved in that transaction. Therefore, that debit card transactions cannot be a part of the credit card issuer rebate system.

Therefore, a need clearly exists for a cash rebate method which will provide particular merchants with the consumer loyalty associated with a rebate system. Such a merchant-associated rebate system would also benefit from being able to operate under one of the many standard credit/debit cards possessed by consumers rather than by requiring the use of an additional card which is also presented along with a form of payment at the time of purchase.

Another benefit of such a system is that the consumer would be able to receive a rebate from the use of a debit card with the merchants and not have to rely on a credit instrument to receive the rebate.

Such benefits are found in the present invention which allows the use of a credit/debit card of a standard credit/debit card issuer to be used at participating merchants by a consumer. As it is the merchant that is providing the consumer with a percentage rebate on the goods purchased, the consumer goodwill becomes focused on the particular merchant as well as the credit card issuer and avoids association with any particular product.

For purposes of convenience hereinafter the term credit card or debit card or credit/debit card may be used in describing the invention. It is to be understood that in such cases both credit and debit card instruments are contemplated by the use of any of the terms credit card or debit card or credit/debit card.

### SUMMARY OF THE INVENTION

The present invention accomplishes the above and other benefits by engaging merchants in a particular locality to participate in the credit/debit card rebate system. The rebate system is run by a rebate system operator and is linked to a credit/debit card issuer such as a bank, savings and loan, credit union or other card issuer using one of the standard array of credit/debit cards available such as Visa® or MasterCard® or American Express®. The system operator, or card issuer acting as the system operator, then recruits and approves merchants to participate in the system. A participating merchant agrees to pay a set percentage rebate into the rebate pool at particular intervals. The rebate a merchant pays is determined by the percentage rebate amount agreed to by the merchant and the system operator as applied to the amount of purchases conducted at the merchant's stores under the issuer's credit/debit card.

Periodically, the merchant transmits its credit/debit card purchase records to a central credit/debit card processor. The processor sorts the merchant's credit/debit card transactions to separate the transactions that were conducted using the credit/debit cards issued by the card issuer sponsoring the cash rebate system. The card issuer transactions are segregated from other credit/debit card purchases and the information relating to the credit/debit card purchases of the card issuer are forwarded to the rebate system operator.

Upon receipt of the credit/debit card transaction information by the rebate system operator the transactions are sorted according to merchant for determination of the merchant rebates. The rebate to be paid by each merchant is calculated and notices are sent to the merchant advising the merchant of the amount of rebate to be paid to the rebate center. A further sorting of the credit/debit card transaction information is to identify the transactions conducted by a particular credit/debit card holder or purchaser. A calculation is then made to determine the amount of rebate to be paid to each credit/debit card holder in relation to the utilization of the issuer's credit/debit card with participating merchants.

Therefore, it is an object of the present invention to allow a participating merchant to pay a rebate to a purchaser who is utilizing a particular issuer's credit/debit card, and to thereby attract consumer loyalty to both the merchant's store and to the credit/debit card issuer.

Another object of the present invention is to permit the consumer to obtain cash rebates on all purchases made using a particular credit/debit card issuer's card at participating merchants.

Yet another object of the present invention is to permit a consumer to receive a cash rebate from the use of a debit card in a transaction with a participating merchant and to avoid using a credit instrument in order to receive the rebate.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention.

### DESCRIPTION OF THE DRAWINGS

Preferred embodiments of the invention, illustrative of the best modes in which the applicant has contemplated applying the principles, are set forth in the following description and are shown in the drawings and are particularly and distinctly pointed out and set forth in the appended claims.

FIG. 1 is a flow chart showing the general operations utilized in performing the present invention.

### DESCRIPTION OF THE PREFERRED EMBODIMENT

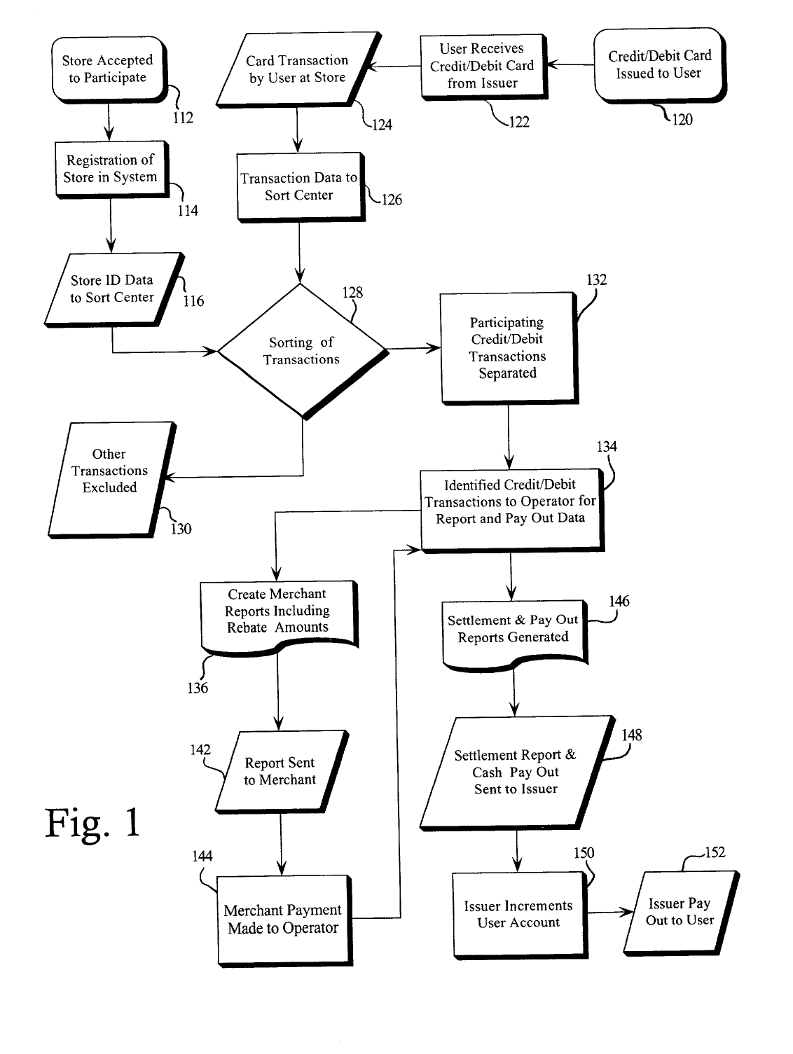

Reference is now made to FIG. 1 wherein a flow chart is shown generally presenting the flow of operations involved in the present cash rebate method invention. Prior to operation of the method, it is necessary to identify acceptable merchants and register the approved merchants that wish to participate in the cash rebate method. When a merchant is identified and approved, an agreement is formed between the merchant and the rebate system operator. The merchant agrees to provide a particular percentage rebate to customers who use the credit/debit card of the issuer.

As shown in FIG. 1, if the merchant is accepted into the rebate system 112, the merchant's electronic credit/debit transaction identification information or identification code is identified to establish registration 114 of the merchant or the store within the cash rebate system. In operation, registration 114 within the rebate system comprises the rebate system operator executing a credit/debit transaction at the merchant's store using identifiable transaction data to later use in tracking the transaction at the processor sorting center. The identifiable information can include transaction time, transaction date, transaction location, card number and/or exact transaction amount. It also is possible to conduct a sequence of unusual transactions in succession to enable tracking at the sorting center. For example, entering a charge of a small amount and immediately entering a credit for the same amount. This transaction is used to identify the merchant's credit/debit transaction identification information. Identification is accomplished once the transaction is transmitted from the merchant to the processor sorting center.

During the business day, the store or merchant transmits all its credit/debit transactions to the central processor. The store or merchant transaction identification information accompanies each transaction that is transmitted for that merchant or store or location. The transmittal by the merchant or store of the rebate system operator's credit/debit transaction provides identifiable electronic transaction information which can be specifically sought out at the processor's sorting center by using the identifiable transaction information which was noted at the time of executing the rebate system operator's credit/debit transaction.

Once the transaction is located the store or merchant transaction identification information can be extracted and confirmed to allow future identification of transactions from that particular store or merchant. It will be appreciated that a search of electronic data sent to the sorting center can be made to identify the rebate system operator's credit/debit transaction. However, it may be more accurate or efficient to for the rebate system operator to first provide the sorting center the receipt information from the credit/debit transaction. This allows the sorting center to simply search for the particular, actual transaction executed by the rebate system operator at the store or merchant.

In a preferred embodiment this is accomplished by the rebate system operator separately presenting to the processor information which will allow the processor to search for the credit/debit card transaction. For example, the transaction numbers on the paper copy of the credit/debit transaction allow a specific search to be conducted by the processor to identify the rebate system operator's credit/debit transaction conducted at the merchant's store during registration transaction 114. When the rebate system operator's credit/debit transaction is isolated at the sorting center, the merchant's electronic credit/debit transaction identification information assigned to that particular store or merchant and the credit/debit card issuer's identification data can be exactly determined. This information is used by the processor to identify and sort future transactions 128 which are made as the merchant participates in the cash rebate system. Registration 114 also comprises the rebate system operator adding the new store or merchant information into the rebate system data bases for use by the rebate operator in calculating the rebates owed by the merchant or store to the customer.

Registration 114 and transmission of identification 116 are critical to effective operation of the present invention as it is important to avoid obtaining merchant identification information that relates to non-participating branches of particular merchant. For example, a particular service station location of a nationally branded gasoline may decide to participate in the cash rebate system. This decision can be made locally as the stations are operated on an owner/operator basis and the individual operator is able to make management decisions at the local level. However, merely attempting to look up the merchant identification information for this particular service station location in a directory of merchants is usually unsuccessful. This is caused by the many similarly named stores operated by other merchants and by the fact that a credit/debit identifier of a particular store may have no relationship to the actual name of the store. For instance, the particular owner/operator of a location of a nationally branded gasoline may not bear the name of the national brand of gasoline such as Conoco®, but may be identified in the credit transactions as Pat's 75th Street Gas.

Therefore, this type of complication in attempting to simply look up in an index the correct merchant identifier information for a participating merchant is best resolved through the method step of conducting a nominal transaction 114 with a known debit/credit card number in order to transmit 116 the actual merchant identification data and merchant transaction data to the transaction sorting processor to permit precise identification of the information which will accompany transactions from that particular merchant.

Still referring to FIG. 1, the method by which the inventive cash rebate system is operated will be discussed. To initiate the method a credit/debit card issuer such as a bank or savings and loan or credit union or other debit/credit card issuer determines to institute the case rebate system as part of its credit/debit card operations and issues cards 120 to users. The issuer then arranges to establish a rebate system operator 134 either as a third party operator or as an entity within the card issuer organization. The rebate system operator 134 then identifies and contacts merchant stores which are interested in participating in the rebate system. Once the merchant stores are identified, the store acceptance 112 and registration 114 and store identification transmission 116 are effected to complete the enrollment of participating merchants within the cash rebate method.

After merchants have been enrolled to participate in the system, and the system becomes operational, the user receiving a credit/debit card 122 from the issuer 120 can begin to make credit/debit transactions with the card at participating merchants 124 to secure cash rebates to the user.

The actual cash rebate program is initiated by a user 122 who has received a credit/debit card from the issuer 120 by using the credit/debit card for a transaction at a store 124. The user will have elected to conduct the transaction at the particular store either from general convenience or happenstance, or with the knowledge the particular store is offering the user a cash rebate on any purchases 124 made at the store. When the issuer's debit/credit card has been utilized in a card transaction by a user 124, the transaction data for the particular purchase transaction 124 is sent 126 to a transaction sorting center 128 along with all credit/debit transactions conducted at that particular merchant's store during a period of time.

The transaction data 126 arrives at a transaction sorting processor where the sorting of transactions 128 occurs. During transaction sorting, the store identification data 116 is used to identify the transactions of the credit/debit card issuer which were conducted at participating merchants and which represent participating credit/debit transactions 132. All other transactions are excluded from this sorting process as non-participating transactions 130. Once participating credit/debit transactions 132 are identified and sorted from non-participating transactions 130, the participating credit/debit transactions 132 can be forwarded to the rebate system operator 134 who processes the participating transactions 132 for preparation of reports and invoices to merchants for payment of rebate amounts and for determination of user rebate payout data 134. It will be appreciated that the rebate system operator can be the same entity as the transaction sorting processor or the operator can be a separate entity.

Several sorting and re-sorting operations and reports and calculations are then conducted by rebate system operator 134 after receiving the participating transactions 132. The sorting and resorting produces groups of credit/debit transactions and each group contains one or more credit/debit transactions.

The sorting allows the rebate system operator to create various reports including merchant reports 136 which states the rebate amount owed by the merchant. This rebate amount can be registered as a debit against the merchant's automatic clearinghouse account. The merchant report 136 is created by sorting all the transactions to isolate the transactions having a particular store's or merchant's identification information. The results of the store/merchant identification information sort is then associated with the rebate percentage agreed to by the merchant. The rebate percentage is multiplied by the amount of the store/merchant total purchases presented in the credit/debit transactions associated with the store/merchant identification information to calculate the amount of rebate the merchant is to pay to the rebate system operator for rebate distributions. A report of this data is created and sent 142 to the merchant. This report advises the merchant of the transactions which were attributed to the merchant's store under the cash rebate system and the report advises the merchant of the rebate amount to be paid 144 to the rebate system operator for distribution.

A second report, the settlement and payout report 146, is generated by the rebate system operator and sent to the credit/debit card issuer 148. Settlement and payout report 146 contains the general parameters of all transactions conducted under the rebate program and includes specific reports for each credit/debit card user 122 which includes each user transaction 124. Settlement and payout report 146 advises the credit/debit card issuer of the amount of rebate due each user. The credit/debit card issuer or rebate system operator then increments each user rebate account 150 by the amount of the rebate due to be paid to the user. The settlement and payout report also may indicate the amount of the merchant paid rebates 144 which is retained by the rebate system operator to pay the system operator for the cost of the rebate operations. At predetermined intervals, usually determined by the credit/debit card issuer, actual payout 152 of the user rebate account is made to the customer or user.

Additional reports may be generated as are deemed necessary by the merchant or rebate system operator or credit card issuer or the transaction sorting center.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Certain changes may be made in embodying the above invention, and in the construction thereof, without departing from the spirit and scope of the invention. It is intended that all matter contained in the above description and shown in the accompanying drawings shall be interpreted as illustrative and not meant in a limiting sense.

Having now described the features, discoveries and principles of the invention, the manner in which the inventive method of providing cash rebates to purchasers is instituted and used, the characteristics of the method, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall there between.

Having thus described the invention, what is claimed as new and desired to be secured by Letters Patent is as follows:

1. A method of selecting credit/debit transactions of a participating merchant to provide a cash rebate to a customer of said participating merchant, the method comprising the steps of:
a) providing a merchant credit/debit transaction identification code of a participating merchant to a credit/debit transaction sorting facility,
b) identifying by said merchant identification code at said sorting facility a one or more credit/debit transactions performed at said participating merchant to generate an identified participating merchant credit/debit transactions group each of said identified transactions in said group having a purchase amount associated therewith.

2. The method as claimed in claim 1 further comprising the step of calculating a rebate amount from said purchase amount of said identified transactions group.

3. The method as claimed in claim 2 further comprising the step of notifying said participating merchant of said rebate amount.

4. The method as claimed in claim 2 further comprising the step of incrementing a customer rebate account by an amount in relation to said rebate amount.

5. The method as claimed in claim 4 further comprising the step of paying said customer at least a portion of said customer rebate account.

6. The method as claimed in claim 1 further comprising the step of selecting at said sorting facility a particular card issuer's credit/debit card transactions.

7. The method as claimed in claim 6 further comprising the step of calculating a rebate amount from said purchase amount of said identified transactions.

8. The method as claimed in claim 7 further comprising the step of notifying said card issuer of said rebate amount.

9. The method as claimed in claim 7 further comprising the step of notifying said merchant of said rebate amount.

10. The method as claimed in claim 7 further comprising the step of incrementing a customer rebate account by an amount in relation to said rebate amount.

11. The method as claimed in claim 10 further comprising the step of paying said customer at least a portion of said customer rebate account.

12. The method as claimed in claim 1 wherein the credit/debit transaction identifier of said merchant is determined by performing a credit/debit transaction at said merchant location.

13. A method for obtaining a cash rebate from a merchant comprising the steps of:
determining a credit/debit transaction identification of a merchant,
registering said merchant transaction identification with a credit/debit transaction sorter,
selecting by said sorter a particular card issuer's credit/debit card transactions to identify an issuer transactions group,
separating by said sorter from said issuer transactions group a one or more transactions having said merchant transaction identification associated therewith to provide a issuer/merchant sorted transactions group.

14. The method as claimed in claim 13 further comprising the step of calculating a rebate amount based on said issuer/merchant sorted transaction group.

15. The method as claimed in claim 13 wherein the credit/debit transaction identifier of said merchant is determined by performing a credit/debit transaction at said merchant location.

16. The method as claimed in claim 14 further comprising the step of notifying said merchant of said rebate amount.

17. The method as claimed in claim 14 further comprising the step of notifying said card issuer of said rebate amount.

18. The method as claimed in claim 14 further comprising the step of incrementing a customer rebate account by an amount in relation to said rebate amount.

19. The method as claimed in claim 18 further comprising the step of paying said customer at least a portion of said customer rebate account.

20. A method for obtaining a cash rebate from a merchant comprising the steps of:
determining a credit/debit transaction identification of a merchant by the method comprising the steps of:
performing a credit/debit transaction at said merchant location,
transmitting data regarding said credit/debit transaction to a credit/debit transaction sorter,
locating said credit/debit transaction data at said transaction sorter,
extracting said merchant transaction identification information from said credit/debit transaction data,
registering said merchant transaction identification information with said credit/debit transaction sorter,
selecting by said sorter a particular card issuer's credit/debit card transactions to identify an issuer transactions group wherein each transaction of said issuer transactions group has a purchase amount associated therewith,
separating by said sorter from said issuer transactions group a one or more transactions having said merchant transaction identification associated therewith to provide a issuer/merchant sorted transactions group, and
calculating a rebate amount from said purchase amount of said issuer/merchant sorted transactions group.

21. The method as claimed in claim 20 further comprising the step of notifying said participating merchant of said rebate amount.

22. The method as claimed in claim 20 further comprising the step of incrementing a customer rebate account by an amount in relation to said rebate amount.

23. The method as claimed in claim 22 further comprising the step of paying said customer at least a portion of said customer rebate account.

24. The method as claimed in claim 20 further comprising the step of notifying said merchant of said rebate amount.
